(19) United States
(12) Patent Application Publication
(10) Pub. No.: US 2015/0236920 A1
(43) Pub. Date: Aug. 20, 2015

(54) METHOD AND APPARATUS FOR DETERMINING CONNECTION INFORMATION OF A LINK

(71) Applicant: TELEFONAKTIEBOLAGET L M ERICSSON (PUBL), Stockholm (SE)

(72) Inventors: Michela Bevilacqua, Genova (IT); Massimiliano Maggiari, Genova (IT); Carla Marcenaro, Genoa (IT)

(73) Assignee: TELEFONAKTIEBOLGET L M ERICSSON (PUBL), Stockholm (SE)

(21) Appl. No.: 14/435,291

(22) PCT Filed: Oct. 17, 2012
(86) PCT No.: PCT/EP2012/070583

§ 371 Date: Apr. 13, 2015

(51) Int. Cl. H04L 12/24; H04L 12/26; H04L 12/911; H04L 29/08

(52) U.S. Cl. CPC H04L 41/12; H04L 67/303; H04L 43/0811; H04L 47/829

(57) ABSTRACT

A method and apparatus is provided for determining connection information of a link between a first port on a first network element and a second port on a second network element. Bidirectional Forwarding Detection discriminator values are defined for both the first port and the second port, BFD signals are sent over the link, and a link connection profile is produced containing the first and second BFD discriminator values. The link connection profile is notified to a network management system, which may then update the network topology with the link connection information.

### TECHNICAL FIELD

This invention relates to a method and apparatus for determining connection information of a link, the link being connected between a first port on a first network element and a second port on a second network element.

### BACKGROUND

A conventional network, such as an Ethernet network, comprises a plurality of network elements managed by a network management system. The network management system is used for administration of the network elements, such as configuration of links between network elements, detecting faults in a network element or a link between two network elements, and performance monitoring.

Traditionally, a network operative manually enters the network topology and related link configurations on the network management system. A link between a first port on a first network element and a second port on a second network element can only be configured once the connection information between the two ports has been manually entered. The network operative must therefore know how links have been connected between different elements of the network before the links can be configured. This process is subject to human mistakes, which results in the network management system having incorrect network topology information, which leads to loss of control of the network.

Thus, manual entry of the connection information is slow, tedious work for the network operative, and error prone. Typically, when an error in the connection information is detected, the network operative must commence a troubleshooting operation to identify and correct the mistake.

It is therefore desirable to alleviate some or all of the above problems.

### SUMMARY

According to a first aspect of the invention, there is provided a method of determining connection information of a link, the link being connected between a first port on a first network element and a second port on a second network element, the first and second network elements being part of a network managed by a network management system, the method comprising the steps of: enabling Bidirectional Forwarding Detection, BFD, protocol on the first port and the second port; defining a first BFD discriminator value associated with the first port and a second BFD discriminator value associated with the second port; populating a link connection profile with the first BFD discriminator value and the second BFD discriminator value; and notifying the network management system of the link connection profile.

The present invention therefore provides a method of discovering connection information of a link between a first and second port using the BFD protocol, by defining a first and second BFD discriminator values that may univocally identify the first and second port respectively. Thus allowing the network management system to automatically discover the topology of the network and the connection information of a link between two network elements in the network.

The method may be implemented on a network having a plurality of links between a plurality of ports on different network elements. Thus, the network management system may be notified of the connection information relating to a plurality of links in the network, such that the network management system may determine the entire network topology and the related link connection information in one discovery process.

This discovery process therefore replaces the manual entry of network topology information on a network management system. The process is therefore much faster and less error prone. The process is also more readily implemented into existing networks, as it uses an existing standard protocol rather than a new protocol defined just for this purpose.

The BFD protocol is defined by Internet Engineering Task Force (IETF) Request for Comments (RFC) 5880 and 5881, D. Katz, D. Ward, June 2010. Conventionally, the BFD protocol is used to detect faults in the bidirectional path between two forwarding engines, including interfaces and data links, and can provide failure detection on any kind of path between systems, including direct physical links, virtual circuits, tunnels, MPLS Label Switched Paths (LSPs), multihop routed paths, and unidirectional links (with a return path). Multiple BFD sessions can be established between a pair of systems.

The step of populating the connection profile may comprise the steps of the first network element populating a first BFD signal with the first BFD discriminator value and sending the first BFD signal to the second network element; and the second network element, on receipt of the first BFD signal, populating a second BFD signal with the first and second BFD discriminator values and sending the second BFD signal to the first network element; and the first network element populating the link connection profile with the first BFD discriminator value and the second BFD discriminator value.

The BFD protocol provides a suitable mechanism for the two network elements to discover the link connection information between the two ports. That is, the network elements may send BFD signals between the two ports, such that the return (second) BFD signal contains the first and second BFD discriminator values, which correspond to the first and second port respectively. Thus, on receipt of a BFD signal, the network element discovers the identity of the remote port connected by a particular link. Each network element may therefore populate a link connection profile for that link, including the identity of the first and second port.

The step of notifying the network management system of the link connection profile may comprise the network management system fetching the link connection profile, requesting BFD discriminator values, or may comprise the network elements spontaneously sending the link connection profile to the network management system in response to receiving the BFD signal. Thus, if the network element supports automatic notification, then the network management system may be automatically notified of the link connection profile. Otherwise, the network management system may fetch the link connection profile. Thus, the network management system may be notified of a link connection profile from each active network element in the network, such that it may quickly discover the entire network topology and related link connection information.

The method may be implemented on demand by the network management system, or in response to a change in a topology in the network. Thus, a network operative may command the network management system to initiate a discovery process, or it may be initiated in response to a change of topology (e.g. a new card installed on a network element).

According to a second aspect of the invention, there is provided a network element, for a network managed by a network management system, the network including a second network element, the network element comprising a first port, for connecting with a second port on the second network element; a processor, configured for enabling Bidirectional Forwarding Detection, BFD, protocol on the first port, such that a first BFD discriminator value is associated with the first port; wherein the first port is configured for receiving a second BFD discriminator value associated with the second port, and the processor is configured for populating a link connection profile with the first BFD discriminator value and the second BFD discriminator value, and the processor is configured for notifying the network management system of the link connection profile.

The first port may be configured for sending a first BFD signal to the second port, the first BFD signal comprising the first BFD discriminator value, and for receiving a second BFD signal, the second BFD signal comprising the first BFD discriminator value and the second BFD discriminator value.

The processor may be configured for notifying the network management system of the link connection profile in response to receiving the second BFD signal.

According to a third aspect of the invention, there is provided a network management system, for managing a network including a first network element having a first port, and a second network element having a second port, the network management system comprising a communication interface, for communicating with the first port and the second port; a processor, configured for sending a message via the communication interface to trigger Bidirectional Forwarding Protocol, BFD, on the first port and second port wherein the communication interface is configured to receive a link connection profile, the link connection profile including a first BFD discriminator value associated with the first port and a second BFD discriminator value associated with the second port.

The network management system may define first and second BFD discriminator values for the first and second port respectively, such that they may univocally define the first and second port within the network. As the network management system has visibility of the full network, it can grant a uniqueness value for each port in the network (i.e. a string based on the Network Element identifier and the Port identifier on the Network Element).

The processor may be configured for fetching the link connection profile via the communication interface.

The processor may be configured for sending a message via the communication interface to trigger BFD on the first port and second port in response to a change of topology in the network.

### BRIEF DESCRIPTION OF THE DRAWINGS

Embodiments of the invention will now be described, by way of example, and with reference to the drawings in which:

FIG. 1 illustrates a network of an embodiment of the present invention, showing a network management system, a first (active) network element, a second (passive) network element, and a link between a first port on the first network element and a second port on the second network element;

FIG. 2a illustrates a first BFD signal, showing a first BFD discriminator value;

FIG. 2b illustrates the first BFD signal of FIG. 2a, showing the composition of the first BFD discriminator value;

FIG. 3a illustrates a second BFD signal, showing a second BFD discriminator value;

FIG. 3b illustrates the second BFD signal of FIG. 3a, showing the composition of the second BFD discriminator value;

FIG. 4 illustrates a link connection profile;

FIG. 5 illustrates a method of determining connection information of a link of a first embodiment of the present invention; and

FIG. 6 illustrates a method of determining connection information of a link of a second embodiment of the present invention when a new card is added to the network.

### DETAILED DESCRIPTION

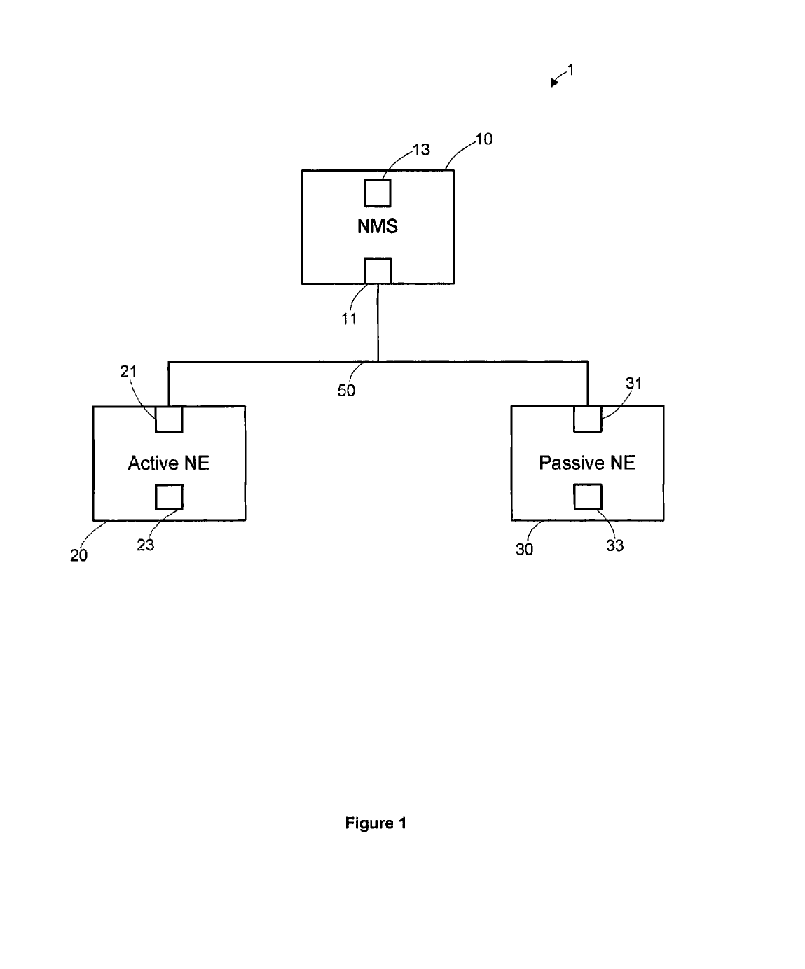

A first embodiment of a network 1 of the present invention will now be described with reference to FIGS. 1 to 5. In this embodiment, the network 1 is an Ethernet network including a first (active) network element 20, a second (passive) network element 30, and a network management system 10 configured to monitor the first and second network elements 20, 30. The network elements 20, 30 and the network management system 10 are all configured to use the Bidirectional Forwarding Detection, BFD, protocol, as defined in RFC5880, RFC5881 (discussed above).

The first network element 20 has a first port 21, the second network element 30 has a second port 31, and the network further comprises a link 50 between the first port 21 and second port 31.

BFD is a form of ‘Hello’ protocol, which may establish a two-way path between the first and second network element. The two-way path may be either a bidirectional link, or a uni-directional link having a separate return path. The BFD protocol includes a ‘My Discriminator’ field, being a discriminator value generated by the transmitting system, and a ‘Your Discriminator’ field, a discriminator value received from a corresponding remote system. The ‘Your Discriminator’ field reflects the received value of ‘My Discriminator’, or ‘0’ (zero) if that field is unknown.

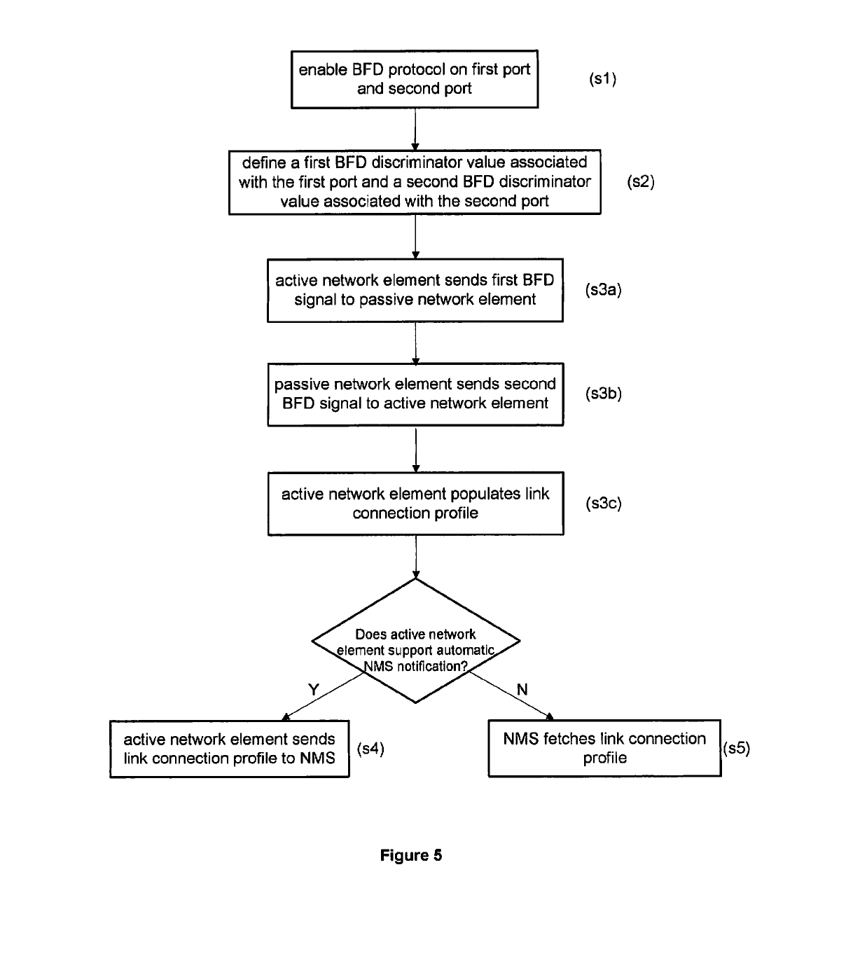

In this embodiment, the first and second network elements 20, 30 include a first and second processor 23, 33 respectively, configured to enable the BFD protocol on each port 21, 31 (step s1 in FIG. 5). To enable the BFD protocol on each port 21, 31, the network management system 10 includes configuration data for the first and second network elements 20, 30 (e.g. on a local database), and sends a first and second message to the first and second network elements 20, 30 respectively, thus triggering the processors 23, 33 to enable the BFD protocol on each port 21, 31. This process may be done automatically by the network management system 10 for all network elements 20, 30 in the network 1, either as a single step or a number of steps.

For simplicity, this embodiment will only describe a first and second network element 20, 30, having a first and second port 21, 31 respectively, but the skilled person will understand that a typical network will have a plurality of network elements each having a plurality of ports, and this process is readily scalable to a network having a more comprehensive topology.

When enabling the BFD protocol on each network element 20, 30, a discriminator value is defined for each port (step s2 in FIG. 5). In this embodiment, the discriminator value for each port on each network element is based on the IP address of the network element (i.e. the IP address of the Ethernet interface assigned from a DHCP or manually by the operator at commissioning time) and the port identifier. Thus, the discriminator value for each port of each network element takes the form of NodeXUniqueID-NodeXUniquePortID.

The first port 21 of the first network element 20 is configured to send a first BFD signal 100 to the second port 31 of the second network element 30 (step s3a in FIG. 5). As the first network element 20 is therefore initializing the BFD procedure, it takes the active role and is hereinafter designated the ‘active network element 20’. In contrast, the second network element 30 awaits BFD packets and is hereinafter designated the ‘passive network element 30’.

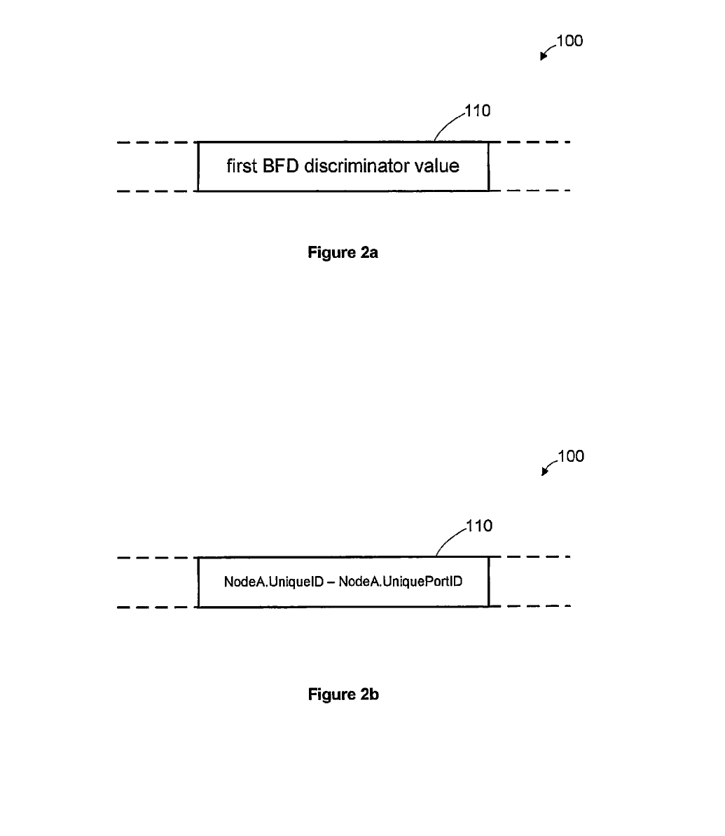

As shown in FIGS. 2a and 2b, the active network element 20 configures the first BFD signal to include the first discriminator value. The first BFD signal 100 is therefore a Hello message taking the form of (Hello-NodeA.UniqueID-NodeA.UniquePortID). The first BFD signal 100 is transmitted to the second port 31 on the passive network element via the link 50.

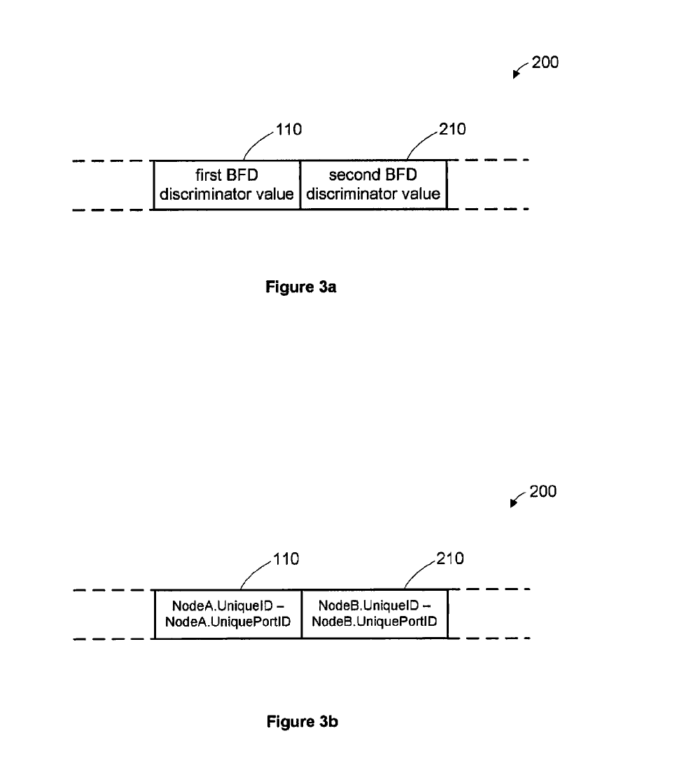

The second port 31 receives the first BFD signal 100, and in response, configures a second BFD signal 200 (step s3b in FIG. 5). As shown in FIGS. 3a and 3b, the passive network element 30 configures the second BFD signal to include the first discriminator value (corresponding to the active network element 20) and the second discriminator value (corresponding to the passive network element 30). The second BFD signal 200 is therefore a Hello acknowledgement message taking the form (Hello ACK-NodeA.UniqueID-NodeA.UniquePortID-NodeB.UniqueID-NodeB.UniquePortID).

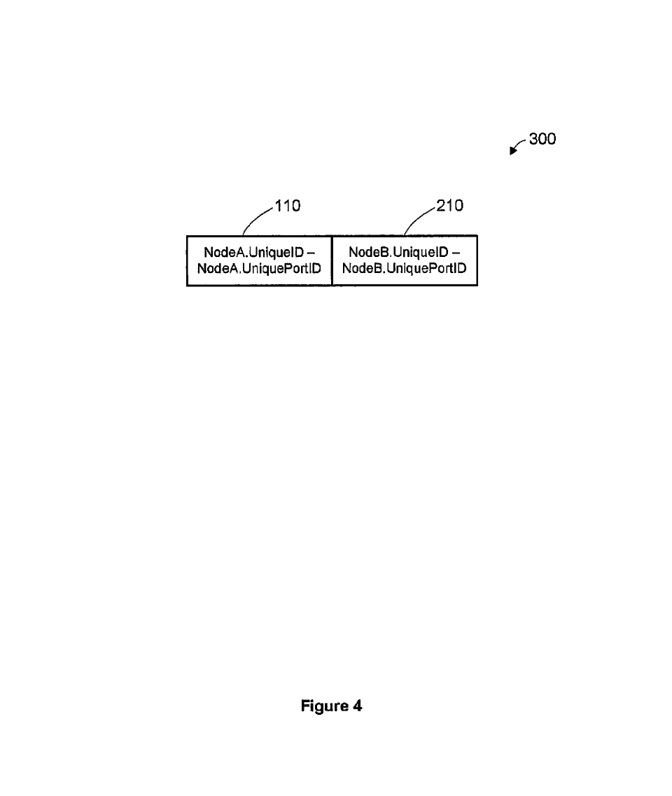

The first port 21 on the active network element 20 is configured to receive the second BFD signal 200, and in response, configures a link connection profile 300 for the link 50 (step s3c in FIG. 5). As shown in FIG. 4, the active network element 20 populates a link connection profile 300 with the first and second discriminator values, thus describing the connection of the link 50 between the first port 21 and second port 31.

In this embodiment, the active network element 20 is configured for automatic notification to the network management system 10. Therefore, the processor 23 of the active network element 20 is configured to initiate the automatic notification (which may be via a connection between the first port 21 and the network management system 10 or an alternative route), such that the link connection profile 300 is sent to the network management system 10 (step s4 in FIG. 5).

On receipt of the link connection profile 300, the network management system 10 is configured to update its network topology data with the connection information of the link 50. That is, the network topology is updated to include the connection between the first port 21 and the second port 31 via link 50. With this information, the network management system 10 may then configure the link 50.

The skilled person will understand that the process is likely to be implemented by a plurality of network elements in a network. Thus, the network management system 10 is likely to receive a plurality of link connection profiles describing connection information of a plurality of links between various network elements in the network. The network management system 10 may therefore populate the network topology with all the information contained in the plurality of link connection profiles to discover the topology of the network. In future discovery processes, the network management system 10 may manage delta changes with respect to a previous discovery process. This may highlight changes in the network topology and reduce the processing power necessary to process the updated network topology.

Furthermore, the skilled person will understand that it is not essential that the network element automatically notifies the network management system of the link connection profile. That is, the network management system may fetch the link connection profile from the network element (step s5 in FIG. 5).

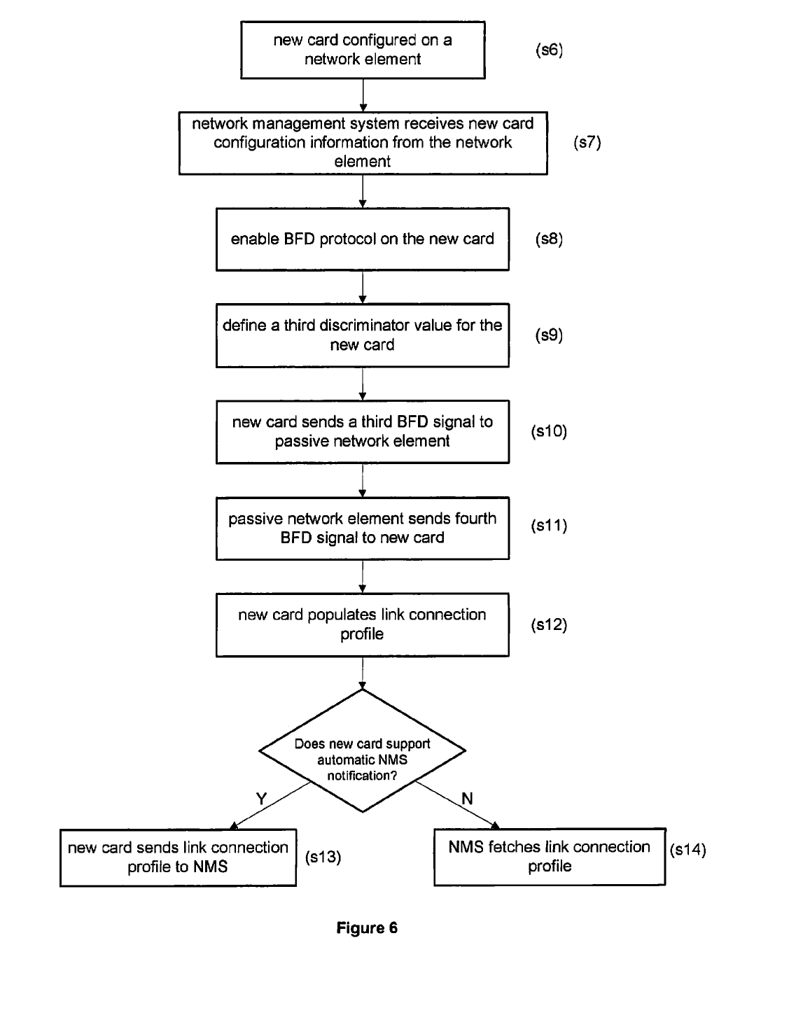

The skilled person will understand that the network operative may implement the discovery process on demand (for example, when commissioning a network or at predetermined intervals). In a second embodiment, the discovery process may be implemented due to a change in topology of the network (for example, when a new card is added to a network element on the network). This will now be described with reference to FIG. 6.

In this embodiment, a new card is configured on a network element (step s6). The network management system receives configuration information for the new card information from the network element (step s7), and the BFD protocol is enabled on the new card (step s8). Accordingly, a third BFD discriminator value is defined for the new card (step s9). The third BFD discriminator value takes the same form as described above.

In a similar manner to the previous embodiment, the new card 40 sends a third BFD signal 400 to a passive network element (step s10). The third BFD signal 400 contains the third BFD discriminator value (related to the new card 40). In response, the passive network element sends a fourth BFD signal 500 to the new card 40, containing the third BFD discriminator value and a BFD discriminator value associated with the passive network element (step s11). The new card 40 then populates a link connection profile 600 with the discriminator values (step s12), which is in turn notified to the network management system either by automatic notification (step s13) or by a fetch process (step s14).

The skilled person will understand that it is not essential that the discriminator values are based on the IP address of the network element. That is, the discriminator value may be any suitable value for the network elements and/or network management system to discern the network element to which that discriminator value is associated from any other network element. For example, the discriminator value may be based on the NSAP (Network Service Access Point) address as defined in defined in ISO/IEC 8348.

In the above embodiments, the network 1 is an Ethernet network. However, the skilled person will understand that the present invention is applicable to many other forms of networks because IETF RFC 5880 that defines BFD indicates that BFD can operate independently of network technology (media, data protocols, routing protocols, etc). In short, this invention can be applied to any media where BFD protocol can be applied. The few most popular network technologies where this invention can be implemented include IP, Ethernet, MPLS-TP, IP/MPLS.

In the above embodiments, the first network element receives a Hello Acknowledgement message back from the second network element, which contains both the first and second discriminator values. The link connection profile is then populated with the first and second discriminator values which is then notified to the network management system. The skilled person will understand, however, that it is possible for the second network element to populate the link connection profile and notify this to the network management system. That is, on receipt of the first BFD signal (containing the first discriminator value), the second network elements populates a link connection profile with the first discriminator value and its own discriminator value, and the profile is notified to the network management system. Thus, it is not essential that the second network element sends the second BFD signal (containing both the first and second discriminator values) to the first network element.

The skilled person will understand that any combination of features is possible within the scope of the present invention, as claimed.

1. A method of determining connection information of a link, the link being connected between a first port on a first network element and a second port on a second network element, the first and second network elements being part of a network managed by a network management system, the method comprising the steps of:
enabling Bidirectional Forwarding Detection (BFD) protocol on the first port and the second port;
defining a first BFD discriminator value associated with the first port and a second BFD discriminator value associated with the second port;
populating a link connection profile with the first BFD discriminator value and the second BFD discriminator value; and
notifying the network management system of the link connection profile.

2. The method as claimed in claim 1, wherein the step of populating the connection profile comprises the steps of:
the first network element populating a first BFD signal with the first BFD discriminator value and sending the first BFD signal to the second network element; and
the second network element, on receipt of the first BFD signal, populating a second BFD signal with the first and second BFD discriminator values and sending the second BFD signal to the first network element; and
the first network element populating the link connection profile with the first BFD discriminator value and the second BFD discriminator value.

3. The method as claimed in claim 1, wherein the step of notifying the network management system of the link connection profile comprises the network management system fetching the link connection profile.

4. The method as claimed in claim 1, wherein the step of notifying the network management system of the link connection profile comprises the first network element sending the link connection profile to the network management system in response to receiving the second BFD signal.

5. The method as claimed in claim 1, implemented on demand by the network management system.

6. The method as claimed in claim 1, implemented in response to a change in a topology in the network.

7. A first network element, for a network managed by a network management system, the network including a second network element, the network element comprising:
a first port, for connecting with a second port on the second network element; and
a processor, configured for enabling Bidirectional Forwarding Detection, protocol on the first port, such that a first BFD discriminator value is associated with the first port; wherein
the first port is configured for receiving a second BFD discriminator value associated with the second port, and the processor is configured for populating a link connection profile with the first BFD discriminator value and the second BFD discriminator value, and
the processor is configured for notifying the network management system of the link connection profile.

8. The network element as claimed in claim 7, wherein the first port is configured for sending a first BFD signal to the second port, the first BFD signal comprising the first BFD discriminator value, and for receiving a second BFD signal, the second BFD signal comprising the first BFD discriminator value and the second BFD discriminator value.

9. The network element as claimed in claim 7, wherein the processor is configured for notifying the network management system of the link connection profile in response to receiving the second BFD signal.

10. A network management system, for managing a network including a first network element having a first port, and a second network element having a second port, the network management system comprising:
a communication interface, for communicating with the first port and the second port; and
a processor, configured for sending a message via the communication interface to trigger Bidirectional Forwarding Protocol (BFD) on the first port and second port, wherein
the communication interface is configured to receive a link connection profile, the link connection profile including a first BFD discriminator value associated with the first port and a second BFD discriminator value associated with the second port.

11. The network management system as claimed in claim 10, wherein the processor is configured for fetching the link connection profile via the communication interface.

12. The network management system as claimed in claim 10, wherein the processor is configured for sending a message via the communication interface to trigger BED on the first port and second port in response to a change of topology in the network.
